(19) United States
(12) Patent Application Publication
(10) Pub. No.: US 2020/0363836 A1
(43) Pub. Date: Nov. 19, 2020

(54) SUPPORT DEVICE FOR A LAPTOP DISPLAY SCREEN

(71) Applicant: Anjum Gupta, San Diego, CA (US)

(72) Inventor: Anjum Gupta, San Diego, CA (US)

(21) Appl. No.: 16/410,240

(22) Filed: May 13, 2019

(51) Int. Cl. G06F 1/16; E05D 3/06; F16M 13/00

(52) U.S. Cl. CPC G06F 1/166; G06F 1/1616; E05Y 2900/606; E05D 3/06; F16M 13/005; G06F 1/1637

(57) ABSTRACT

The disclosure provides a supporting device for a laptop display screen. The device includes a first pair of rotatable support arms, which are attached to a side of the laptop body; a second pair of rotatable support arms, which are attached to the first pair of rotatable support arms and are connected to the laptop display screen. The device also includes a pair of support legs, which are rotatably attached to the second pair of support arms.

### FIELD OF THE INVENTION

The present disclosure generally relates to laptop computers, and more particularly, to support devices that can be used to angularly position a laptop computer above a base surface.

### BACKGROUND OF THE INVENTION

In recent years, there has been a tremendous growth in the sale of laptop computers and notebook computers. Laptop computers are very useful instruments, which essentially present a computer to the user in a convenient compact fashion. Typically, the screen of the laptop computer is a liquid crystal display. The screen of the laptop computer can fold upon the body of the computer so as to close when not in use. When the laptop computer is in use, the screen is folded about its hinges as to face the user. The bottom surface of the laptop computer is typically placed on a table, on a lap, or other flat surface. Various devices such as power supplies, modems, external drives, and other items can also be connected to the laptop computer so as to enhance the use of the laptop computer.

While the design of the laptop computer is optimized for compactness and convenience, but not necessarily for optimum ergonomic efficiency. When the laptop computer is placed on a flat surface, the screen of the laptop computer often does not face the user directly. As such, the user of the laptop computer must slouch or otherwise manipulate the screen so as to be in an optimal viewing position. The screen at this angle can also reflect an undesirable glare from overhead lighting. Therefore, there remains a need in the art for devices and methods for supporting a laptop display screen for the convenience of the user.

### SUMMARY OF THE INVENTION

The disclosed embodiments are directed to solving one or more of the problems presented in the prior art, as well as providing additional features that will become readily apparent by reference to the following detailed description when taken in conjunction with the accompanying drawings.

Thus, in an embodiment, the disclosure provides a laptop display screen supporting device, having a first pair of support arms, each support arm having a proximal end and a distal end, wherein each proximal end is rotatably attachable to a side of a laptop body; a second pair of support arms, each support arm having a proximal end and an interconnected distal end, wherein each proximal end is rotatably attachable to each distal end of the first pair of support arms, and the interconnected distal end of the second pair of support arms is connectable to a laptop display screen, wherein the laptop display screen is rotatable about a longitudinal axis in the interconnected distal end; and a pair of support legs, each support leg having an interconnected proximal end and a distal end, wherein each distal end is rotatably attachable to each proximal end of the second pair of support arms.

In other embodiments, the disclosure provides a supporting device for a laptop screen, having a first pair of rotatable support arms, each arm attachable to a side of a laptop body; a second pair of rotatable support arms, each arm, attachable to the first pair of rotatable support arms and connectable to a laptop display screen; and a pair of support legs, each leg, rotatably attachable to the second pair of support arms.

### BRIEF DESCRIPTION OF THE DRAWINGS

The disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 provides a perspective front view of a laptop computer display screen support device in accordance with an embodiment of the invention;

FIG. 2 provides a perspective rear view of a laptop computer 100 having a display screen support device 101 in accordance with one embodiment of the invention;

FIG. 3 provides a perspective front view of a laptop computer 100 having a display screen support device 101 in accordance with one embodiment of the invention;

FIG. 4 provides another perspective front view of a laptop computer 100 having a display screen support device 101 in accordance with one embodiment of the invention;

FIG. 5 provides a perspective front right view of a laptop computer 100 having a display screen support device 101 in accordance with one embodiment of the invention;

FIG. 6 provides a perspective front left view of a laptop computer 100 having a display screen support device 101 in accordance with one embodiment of the invention; and

FIG. 7 provides a perspective right rear view of a laptop computer 100 having a display screen support device 101 in accordance with tare embodiment of the invention.

Further features and advantages of the disclosure, as well, as the structure and operation of various embodiments of the disclosure, are described in detail below with reference to the accompanying drawings.

### DETAILED DESCRIPTION OF THE EMBODIMENTS OF THE INVENTION

The following description is presented to enable a person of ordinary skill in the art to make and use embodiments described herein. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the disclosure. Thus, the disclosure is not intended to be limited to the examples described herein and shown, but is to be accorded the scope consistent with the claims.

The word “exemplary” is used herein to mean “serving as an example illustration.” Any aspect or design described herein as “exemplary” is not necessarily to be construed as preferred or advantageous over other aspects or designs.

It should be understood that the specific order or hierarchy of steps in the process disclosed herein is an example of exemplary approaches. Based upon design preferences, it is understood that the specific order or hierarchy of steps in the processes can be rearranged while remaining within the scope of the disclosure. Any accompanying method claims present elements of the various steps in a sample order, and are not meant to be limited to the specific order or hierarchy presented.

As used herein, the term “laptop computer” can include various types of small portable computers. For example, the term “laptop computer” can include laptops, notebook and sub-notebook computers, palm-top computers, word processors, pocket computers and electronic organizers, and micro-computers, as well as keyboards and keyboard substitutes such as keypads and electronic writing and drawing pads for pen-based computing.

The disclosure provides a laptop display screen supporting device, having a first pair of support arms, each support arm having a proximal end and a distal end, wherein each proximal end is rotatably attachable to a side of a laptop body; a second pair of support arms, each support arm having a proximal end and an interconnected distal end, wherein each proximal end is rotatably attachable to each distal end of the first pair of support arms, and the interconnected distal end of the second pair of support arms is connectable to a laptop display screen, wherein the laptop display screen is rotatable about a longitudinal axis in the interconnected distal end; and a pair of support legs, each support leg having an interconnected proximal end and a distal end, wherein each distal end is rotatably attachable to each proximal end of the second pair of support arms.

In embodiments, the laptop display screen further provides the first pair of support arms capable of rotating about a longitudinal axis in the side of the laptop body from about 0 degrees to about 180 degrees.

In embodiments, the laptop display screen further provides the first pair of support arms capable of rotating about the longitudinal axis in the side of the laptop body from about 0 degrees to about 150 degrees.

In embodiments, the laptop display screen further provides the second pair of support arms capable of rotating about a longitudinal axis parallel to a longitudinal axis in the side of the laptop body from about 0 degrees to about −120 degrees.

In embodiments, the laptop display screen further provides the second pair of support arms capable of rotating about the longitudinal axis parallel to the longitudinal axis in the side of the laptop body from about 0 degrees to about −90 degrees.

In embodiments, the laptop display screen further provides the pair of support legs capable of rotating about a longitudinal axis parallel to a longitudinal axis in the side of the laptop body from about 0 degrees to about 180 degrees.

In embodiments, the laptop display screen further provides the pair of support legs capable of rotating about the longitudinal axis parallel to the longitudinal axis in the side of the laptop body from about 0 degrees to about 150 degrees.

In embodiments, the laptop display screen further provides the laptop display screen capable of rotating about a longitudinal axis parallel to a longitudinal axis in the side of the laptop body from about 0 degrees to about 120 degrees.

In embodiments, the laptop display screen further provides the laptop display screen capable of rotating about the longitudinal axis parallel to the longitudinal axis in the side of the laptop body from about 0 degrees to about 90 degrees.

In embodiments, the laptop display screen further provides the interconnected distal end of the second pair of support arms being substantially parallel to a longitudinal axis in the side of the laptop body.

In embodiments, the laptop display screen further provides that the display screen is between 10 inches and 18 inches.

In embodiments, the laptop display screen further provides that the display screen is about 10.1, 11.6, 12.1, 13.3, 14.0, 15.6, 16.0 or 17.3 inches.

In embodiments, the laptop display screen further provides that the first pair of support arms, the second pair of support arms, and the pair of support legs, are each independently made of plastic, polymer, fiberglass, carbon fiber, composite, metal, or a metal alloy.

In other embodiments, the disclosure provides a supporting device for a laptop screen, having a first pair of rotatable support arms, each arm attachable to a side of, a laptop body; a second pair of rotatable support arms, each arm attachable to the first pair of rotatable support arms and connectable to a laptop display screen; and a pair of support legs, each leg rotatably attachable to the second pair of support arms.

In embodiments, the disclosure provides a supporting device for a laptop screen having the first pair of rotatable support arms capable of rotating about an axis in aside of the laptop body from about 0 degrees to about 180 degrees.

In embodiments, the disclosure provides a supporting device for a laptop screen having the second pair of rotatable support arms capable of rotating about an axis parallel to an axis in the side of the laptop body from about 0 degrees to about 120 degrees.

In embodiments, the disclosure provides a supporting device for a laptop screen having the pair of support legs capable of rotating about an axis parallel to an axis in the side of the laptop body from about 0 degrees to about 180 degrees.

In embodiments, the disclosure provides a supporting device for a laptop screen having the laptop display screen capable of rotating about an axis parallel, to an axis in the side of the laptop body from about 0 degrees to about 120 degrees.

In embodiments, the disclosure provides a supporting device for a laptop screen having the second pair of support arms connectable to the laptop display screen being substantially parallel to an axis in the side of the laptop body.

In embodiments, the disclosure provides a supporting device for a laptop screen, wherein the display screen is between about 10 inches and 18 inches.

Reference will now be made in detail to aspects of the subject technology, examples of which are illustrated in the accompanying drawings, wherein like reference numerals refer to like elements throughout.

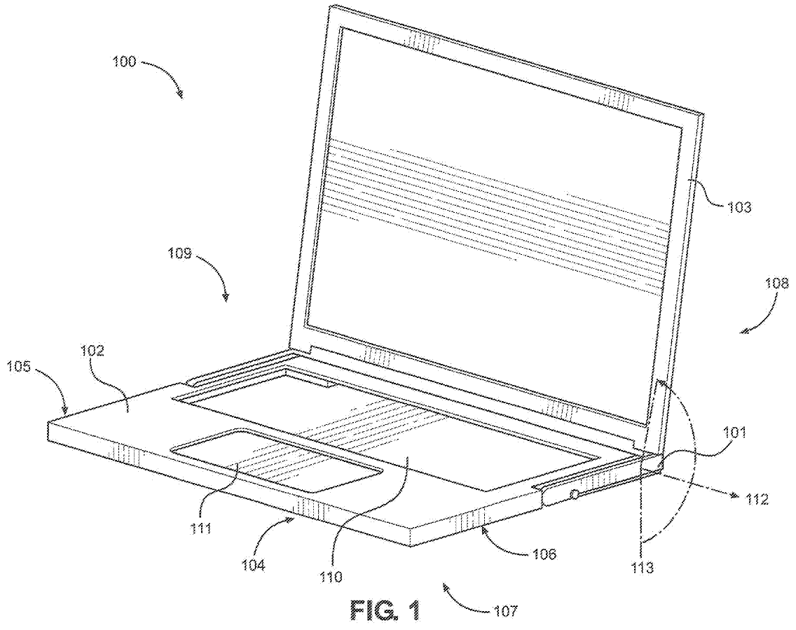

FIG. 1 provides an embodiment of a perspective front view of a laptop computer 100 having a display screen support device 101 as shown in the closed position. As used herein, all description of the sides of the laptop computer are with respect to a user's point of view while in front of the computer during normal operation. Thus, the laptop computer 100 includes a base 102, which contains the various electrical components for operation of the computer, and a display screen 103.

The base 102 includes a front side 104, a left side 105, a right side 106, a bottom side 107, a rear side 108, and a top side 109. The top side includes a keyboard 110, a touchpad 111, and which is pivotally attached the display screen 103. As with most laptop computers, the display screen can rotate along a longitudinal axis 112 through the base 102 by a hinge mechanism 113 so that the screen can toggle between a closed position (˜0 degrees) through to an opened position (˜180 degrees).

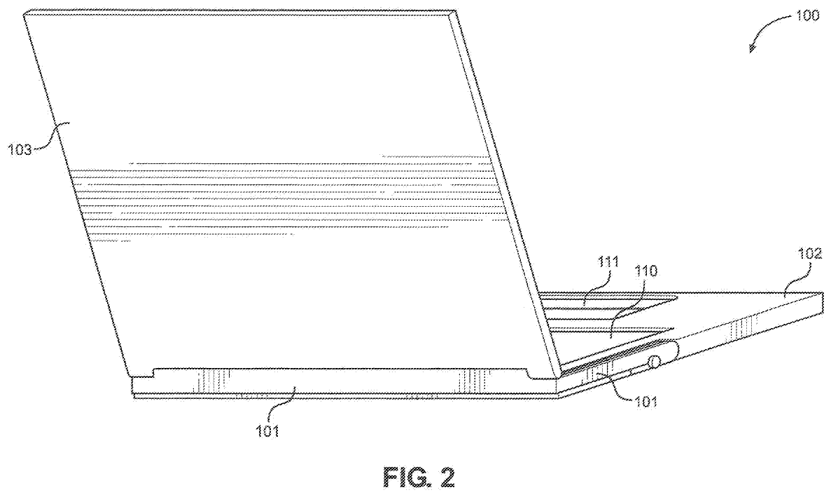

FIG. 2 provides an embodiment of a perspective rear view of a laptop computer 100 having a display screen support device 101 as shown in the closed position. In this figure, the laptop computer 100 includes the base 102, the keyboard 110, the touchpad 111, and the pivotally attached display screen 103.

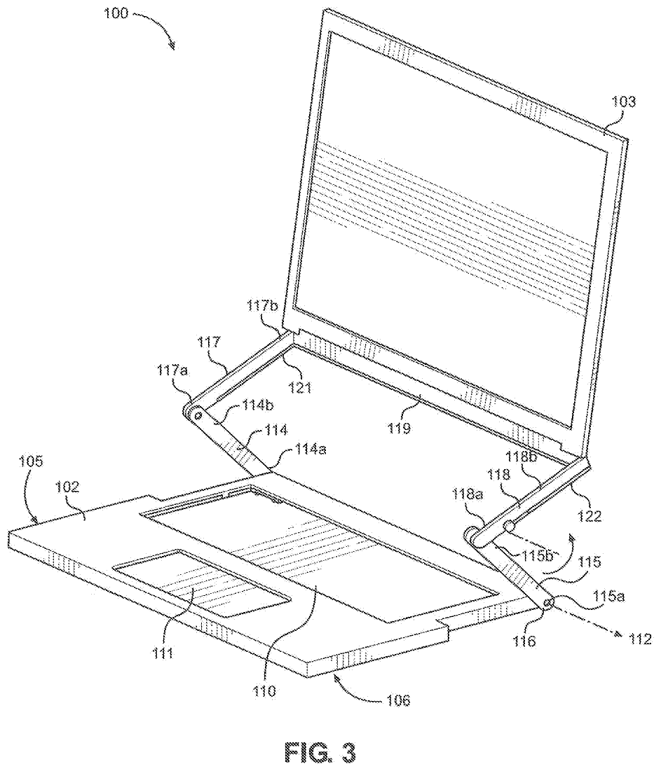

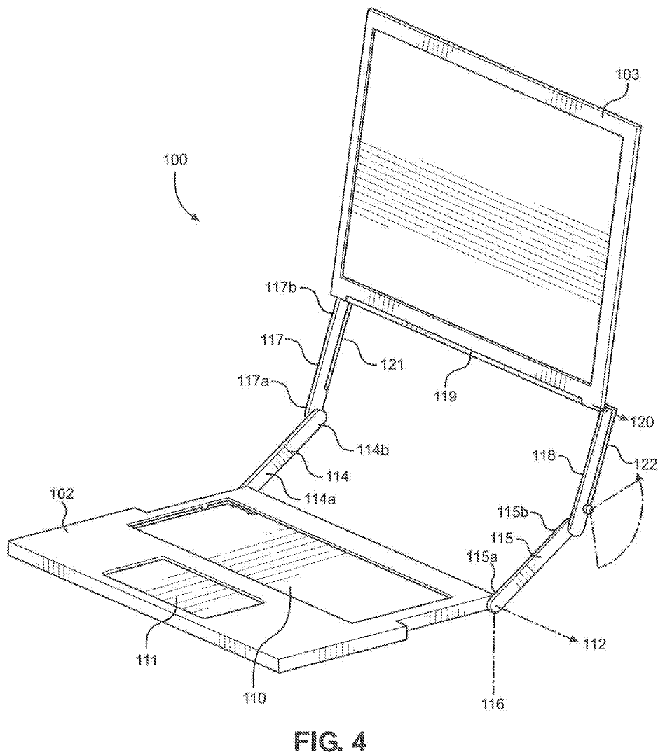

FIGS. 3 and 4 provide embodiments of a perspective front view of a laptop computer 100 having a display screen support device 101 as shown in an initial opened position and a further opened position, respectively.

As shown in these figures, the laptop computer 100 includes the base 102, the display screen 103, the keyboard 110, and the touchpad 111. The display screen support device 101 can be initially lifted upwards from the closed position (as shown in FIGS. 1 and 2) into an initial opened position, which results in the display screen being elevated.

The display screen support device 101 includes a first pair of support arms 114 and 115, wherein each support arm includes a proximal end 114a and 115a, respectively, and a distal end 114b and 115b, respectively. The proximal ends 114a and 115a are each rotatably attachable to the left side 105 and to the right side 106 of the laptop body 102, respectively. That is, the two support arms 114 and 115 each independently pivot along the longitudinal axis 112 through the body 102 by a hinge mechanism 116.

The display screen support device 101 further includes a second pair of support arms 117 and 118, wherein each support arm also includes a proximal end 117a and 118a, respectively, and an interconnected distal end 119. The proximal ends 117a and 118a are rotatably attachable to the distal ends 114b and 115b of the first pair of support arms 114 and 115, respectively. The interconnected distal end 119 of the second pair of support arms 117 and 178, can be connected to the laptop display screen 103. The display screen can be rotated about a longitudinal axis 120 through the interconnected distal end 119. The display screen support device 101 also includes a pair of support legs 121 and 122, which can be interconnected and are, shown in the closed position.

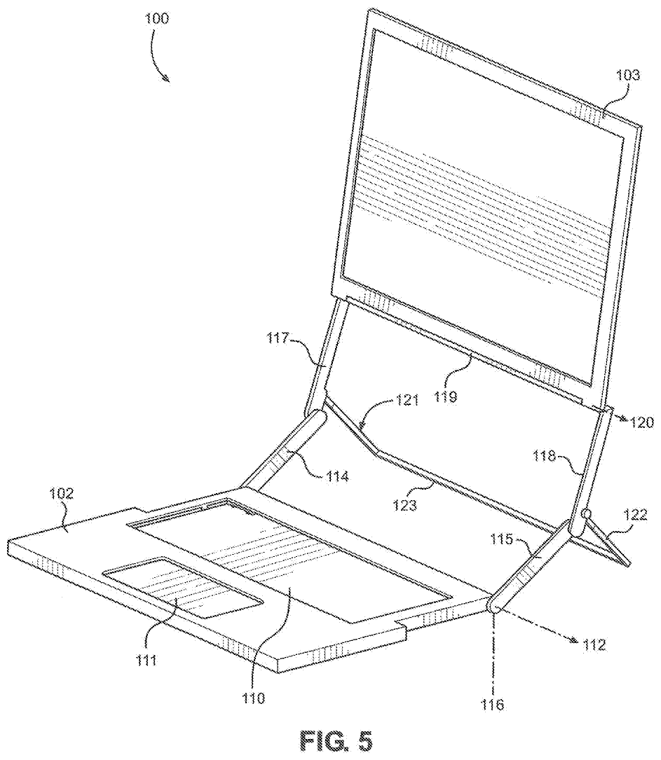

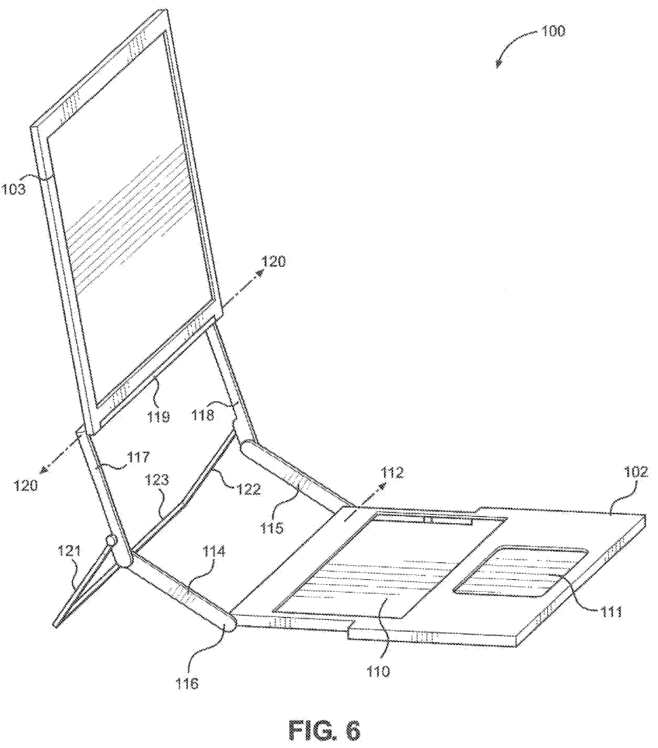

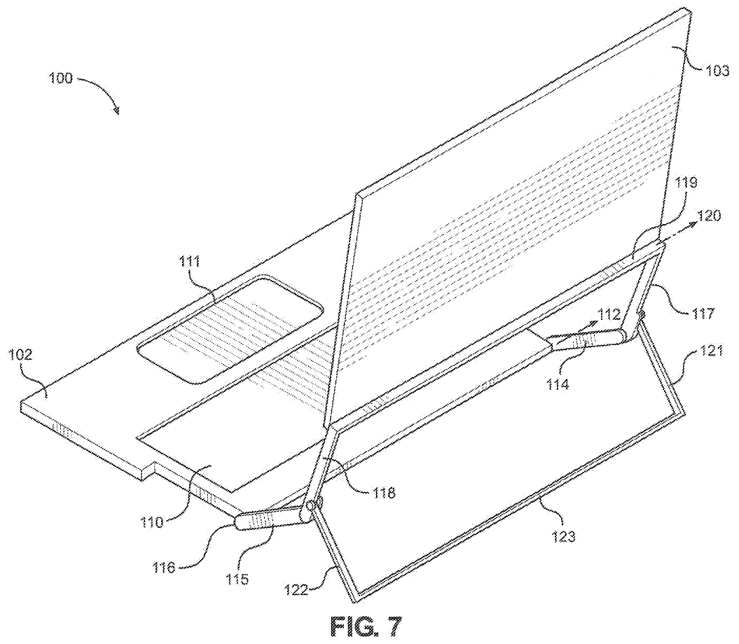

FIGS. 5, 6 and 7 provide embodiments of a perspective front right view, front left view, and rear right view of a laptop computer 100 having a display screen support device 101 as shown in a final closed position, respectively. As shown in these figures, the laptop computer 100 includes the base 102, the display screen 103, the keyboard 110, and the touchpad 111. The display screen support device 101 includes a pair of support legs 121 and 122, which can be interconnected 123, and are shown in the opened position.

As shown in these figures, the display screen support device can be lilted upwards to provide an elevated display screen, preferably to near eye level of the user, and conversely, in reverse order, lowered downward to provide the display screen in the standard laptop display screen opened or closed position.

While the inventive features have been particularly shown and described with reference to preferred embodiments thereof, it will be understood by those in the art that the foregoing and other changes can be made therein without departing from the spirit and the scope of the disclosure. Likewise, the various diagrams may depict an example architectural or other configuration for the disclosure, which is done to aid in understanding the features and functionality that can be included in the disclosure. The disclosure is a of restricted to the illustrated example architectures or configurations, but can be implemented using a. variety of alternative architectures and configurations. Additionally, although the disclosure is described above in terms of various exemplary embodiments and implementations, it should be understood that the various features and functionality described in one or more, of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus, the breadth and scope of the disclosure should not be limited by any of the above-described exemplary embodiments.

1. A laptop display screen supporting device, comprising:
a first pair of support arms, each support arm having a proximal end and a distal end, wherein each proximal end is rotatably attachable to a side of a laptop body; and
a second pair of support arms, each support arm having a proximal end and an interconnected distal end, wherein each proximal end is rotatably attachable to each distal end of the first pair of support arms, and the interconnected distal end of the second pair of support arms is connectable to a laptop display screen, wherein the laptop display screen is rotatable about a longitudinal axis in the interconnected distal end.

2. The laptop display screen of claim 1, further comprising:
a pair of support legs, each support leg having an interconnected proximal end and a distal end, wherein each distal end is rotatably attachable to each proximal end of the second pair of support arms.

3. The laptop display screen of claim 1, further comprising the first pair of support arms capable of rotating about a longitudinal axis in the side of the laptop body from about 0 degrees to about 180 degrees.

4. The laptop display screen of claim 3, further comprising the first pair of support arms capable of rotating about the longitudinal axis in the side of the laptop body from about 0 degrees to about 150 degrees.

5. The laptop display screen of claim 1, further comprising the second pair of support arms capable of rotating about a longitudinal axis parallel to a longitudinal axis in the side of the laptop body from about 0 degrees to about −120 degrees.

6. The laptop display screen of claim 5, further comprising the second pair of support arms capable of rotating about the longitudinal axis parallel to the longitudinal axis in the side of the laptop body from about 0 degrees to about −90 degrees.

7. The laptop display screen of claim 2, further comprising the pair of support legs capable of rotating about a longitudinal axis parallel to a longitudinal axis in the side of the laptop body from about 0 degrees to about 180 degrees.

8. The laptop display screen of claim 7, further comprising the pair of support legs capable of rotating about the longitudinal axis parallel to the longitudinal axis in the side of the laptop body from about 0 degrees to about 150 degrees.

9. The laptop display screen of claim 1, further comprising the laptop display screen capable of rotating about a longitudinal axis parallel to a longitudinal axis in the side of the laptop body from about 0 degrees to about 120 degrees.

10. The laptop display screen of claim 9, further comprising the laptop display screen capable of rotating about the longitudinal axis parallel to the longitudinal axis in the side of the laptop body from about 0 degrees to about 90 degrees.

11. The laptop display screen of claim 1, further comprising the interconnected distal end of the second pair of support arms being substantially parallel to a longitudinal axis in the side of the laptop body.

12. The laptop display screen of claim 1, wherein the display screen is between 10 inches and 18 inches.

13. The laptop display screen of claim 11, wherein the display screen is 10.1, 11.6, 12.1, 13.3, 14.0, 15.6, 16.0 or 17.3 inches.

14. The laptop display screen of claim 2, wherein the first pair of support arms, the second pair of support arms, and the pair of support legs are each independently made of plastic, polymer, fiberglass, carbon fiber, composite, metal, or a metal alloy.

15. A supporting device for a laptop screen, comprising:
a first pair of rotatable support arms, each arm attachable to a side of a laptop body; and
a second pair of rotatable interconnected support arms, each arm attachable to the first pair of rotatable support arms, and each arm connectable to a laptop display screen.

16. The supporting device of claim 15, further comprising:
a pair of support legs, each leg rotatably attachable to the second pair of support arms.

17. The supporting device of claim 15, further comprising the first pair of rotatable support arms capable of rotating about an axis in a side of the laptop body from about 0 degrees to about 180 degrees.

18. The supporting device of claim 15, further comprising the second pair of rotatable support arms capable of rotating about an axis parallel to an axis in the side of the laptop body from about 0 degrees to about −120 degrees.

19. The supporting device of claim 16, further comprising the pair of support legs capable of rotating about an axis parallel to an axis in the side of the laptop body from about 0 degrees to about 180 degrees.

20. The supporting device of claim 15, further comprising the laptop display screen capable of rotating about an axis parallel to an axis in the side of the laptop body from about 0 degrees to about 120 degrees.

21. The supporting device of claim 15, further comprising the second pair of support arms connectable to the laptop display screen being substantially parallel to an axis in the side of the laptop body.

22. The supporting device of claim 15, wherein the display screen is between 10 inches and 18 inches.
